(19) United States
(12) Patent Application Publication
(10) Pub. No.: US 2024/0140432 A1
(43) Pub. Date: May 2, 2024

(54) LONG-DISTANCE AUTONOMOUS LANE CHANGE

(71) Applicant: Baidu USA LLC, Sunnyvale, CA (US)

(72) Inventors: Yifei JIANG, Sunnyvale, CA (US); Zhan SHI, Sunnyvale, CA (US); Ang LI, Sunnyvale, CA (US)

(21) Appl. No.: 17/978,033

(22) Filed: Oct. 31, 2022

(51) Int. Cl. B60W 30/18; B60W 30/09; B60W 30/095; B60W 40/02; B60W 40/105; B60W 60/00

(52) U.S. Cl. CPC B60W 30/18163; B60W 30/09; B60W 30/0956; B60W 40/02; B60W 40/105; B60W 60/0011; B60W 60/0013; B60W 60/0015; B60W 2555/60; B60W 2556/40

(57) ABSTRACT

A long-distance lane change planning of an ADV is performed. A driving environment is perceived based on sensor data obtained from a plurality of sensors mounted on an ADV, including obtaining information of one or more obstacles on an adjacent lane. In response to a request to make a lane change from a current lane on which the ADV is driving to the adjacent lane, an S-V map is generated based on the information of the one or more obstacles. Each point on the S-V map represents a state of the ADV including a distance and a speed of the ADV. A trajectory of the ADV is generated using dynamic programming based on the S-V map. The ADV is controlled to drive autonomously according to the trajectory to make the lane change to the adjacent lane and avoid the one or more obstacles.

### TECHNICAL FIELD

Embodiments of the present disclosure relate generally to operating autonomous driving vehicles. More particularly, embodiments of the disclosure relate to planning for an autonomous driving vehicle (ADV).

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. It is important to perform planning to avoid obstacles. However, it is challenging to plan at a distance to make a lane change to a target lane. It is difficult to find a gap such that the ADV can safely to make the lane change. Conventional attempts to solve the problem only work in certain conditions, but not in all conditions.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system including a lane change planner used with an autonomous driving vehicle according to one embodiment.

FIG. 4 is a block diagram illustrating an example of a decision and planning system according to one embodiment.

FIG. 5 is a block diagram illustrating a lane change planner used with an autonomous driving vehicle according to one embodiment.

FIG. 6 illustrates an example of a long-distance lane change planning of an autonomous driving vehicle according to one embodiment.

FIG. 7 illustrate an example of generating an S-V map according to one embodiment.

FIG. 8 is a diagram illustrating an example of planning a long-distance lane change using dynamic programming of an autonomous driving vehicle according to one embodiment.

FIGS. 9A-9C illustrate an example of planning a long-distance lane change based on an S-V map of an autonomous driving vehicle according to one embodiment.

FIG. 10 is a flow diagram illustrating an example of a process of planning a long-distance lane change of an autonomous driving vehicle according to one embodiment.

FIG. 11 is a flow diagram illustrating an example of a method of performing a long-distance lane change of an autonomous driving vehicle according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some aspects, a long-distance lane change planning may be decomposed into a preparation phase and a lane change phase. The preparation phase for the ADV may include the ADV driving straight within the current lane with varying speeds in a preparation operating mode. The lane change phase may involve maneuvering the ADV towards the target lane in a lane change operating mode. It is important to determine when and where is a spot to switch the ADV from the preparation mode to the lane change mode. The spot to switch operating modes may be determined automatically based on an S-V map, in which each point representing a state of the ADV including a distance and a speed of the ADV. Dynamic programming (DP) may be used to search for the best trajectory that optimizes a metric, which may involve multiple measurements including smoothness, safety, efficiency and constraints.

According to some embodiments, a driving environment is perceived based on sensor data obtained from a plurality of sensors mounted on an ADV, including obtaining information of one or more obstacles on an adjacent lane. In response to a request to make a lane change from a current lane on which the ADV is driving to the adjacent lane, an S-V map is generated based on the information of the one or more obstacles. Each point on the S-V map represents a state of the ADV including a distance and a speed of the ADV. A trajectory of the ADV is generated using dynamic programming based on the S-V map. The ADV is controlled to drive autonomously according to the trajectory to make the lane change to the adjacent lane and avoid the one or more obstacles.

In one embodiment, one or more areas in the S-V map is determined based on one or more predetermined objectives, each point in the one or more areas representing a feasible state for the ADV to make the lane change.

In one embodiment, the lane change includes a preparation phase in which the ADV drives straight within the current lane in a preparation operating mode and a lane change phase in which the ADV maneuvers towards the adjacent lane in a lane change operating mode.

In one embodiment, the trajectory includes a first portion in which the ADV drives straight on the current lane in the preparation phase and a second portion in which the ADV makes a lane change towards the adjacent lane in the lane change phase.

In one embodiment, a transition point in the one or more areas in the S-V map is determined for the ADV to switch from the preparation operating mode to the lane change operating mode based on a plurality of cost functions.

In one embodiment, a state of the AVD is kept within the one or more areas in the S-V map during the lane change phase.

In one embodiment, a lane change cost function is determined based on the S-V map.

In one embodiment, a value of the lane change cost function is determined based on a position of a corresponding point in the S-V map.

In one embodiment, a value of the lane change cost function is infinite for a corresponding point outside the one or more areas in the S-V map.

In one embodiment, a plurality of trajectories of the ADV is generated using dynamic programming. A trajectory is selected from the plurality of trajectories based on the plurality of cost functions including the lane change cost function.

In one embodiment, the plurality of cost functions further includes at least one of a safety cost function, a comfort cost function, an efficiency cost function or a traffic law cost function.

In one embodiment, a combination cost function is determined based on a combination of the plurality of cost functions. A trajectory is selected from the plurality of trajectories based on a lowest cost value of the combination cost function.

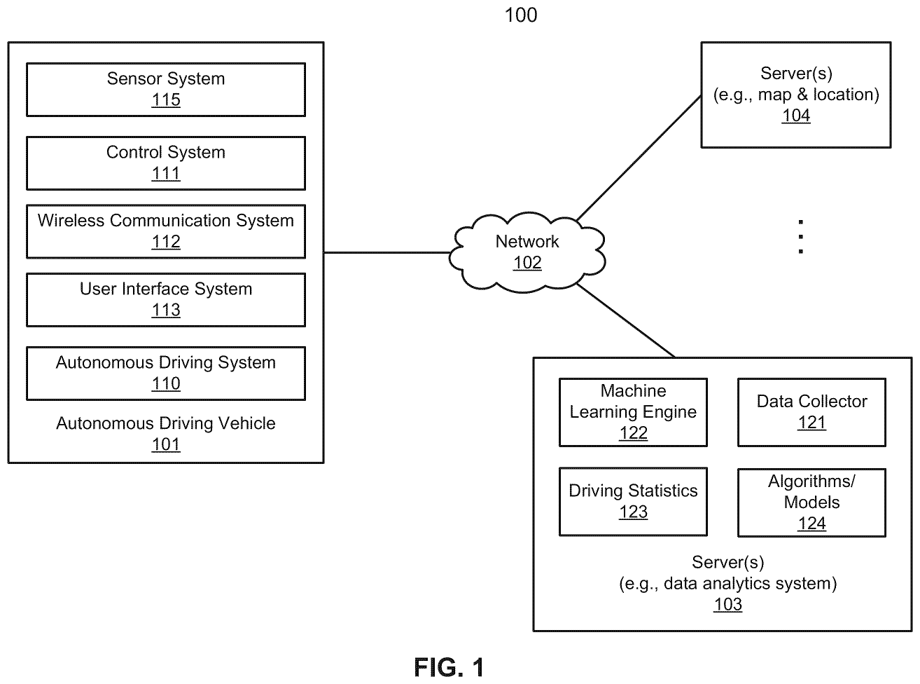

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

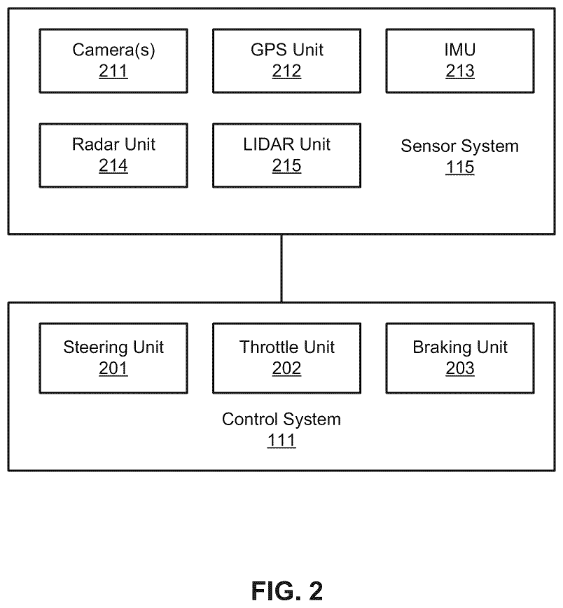

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an WIPOI server, which may be a part of servers 103-104. The location server provides location services and the WIPOI server provides map services and the POIs of certain locations. Alternatively, such location and WIPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. In one embodiment, algorithms 124 may include an algorithm or model to perceive a driving environment based on sensor data obtained from a plurality of sensors mounted on the ADV, including obtaining information of one or more obstacles on an adjacent lane, an algorithm to, in response to a request to make a lane change from a current lane on which the ADV is driving to the adjacent lane, generate a S-V map based on the information of the one or more obstacles, each point on the S-V map representing a state of the ADV, an algorithm to generate a trajectory of the ADV using dynamic programming based on the S-V map, and/or an algorithm to control the ADV to drive autonomously according to the trajectory to make the lane change to the adjacent lane and avoid the one or more obstacles. Algorithms 124 can then be uploaded on ADVs to be utilized during autonomous driving in real-time.

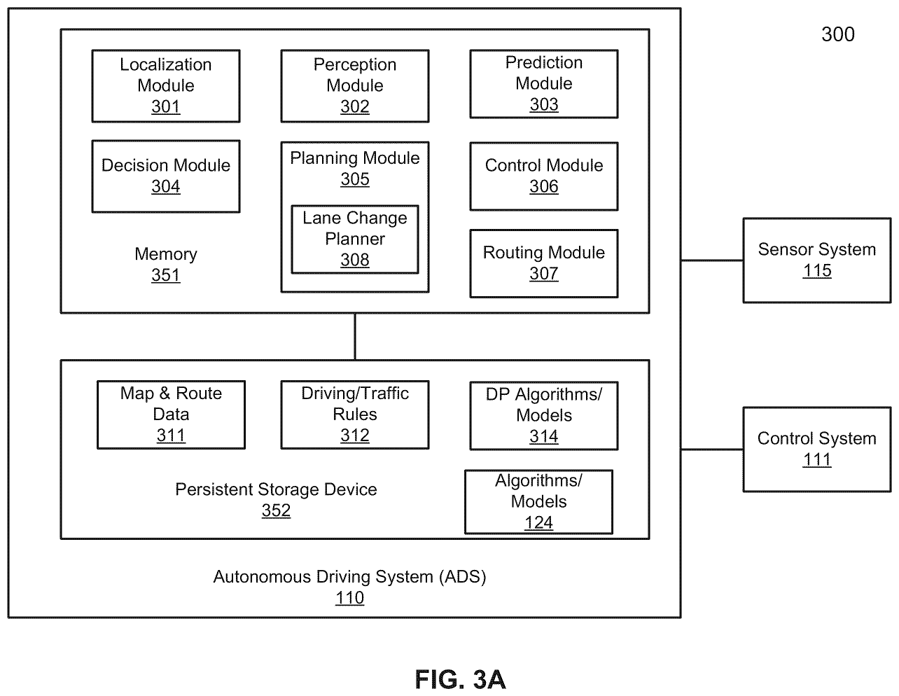

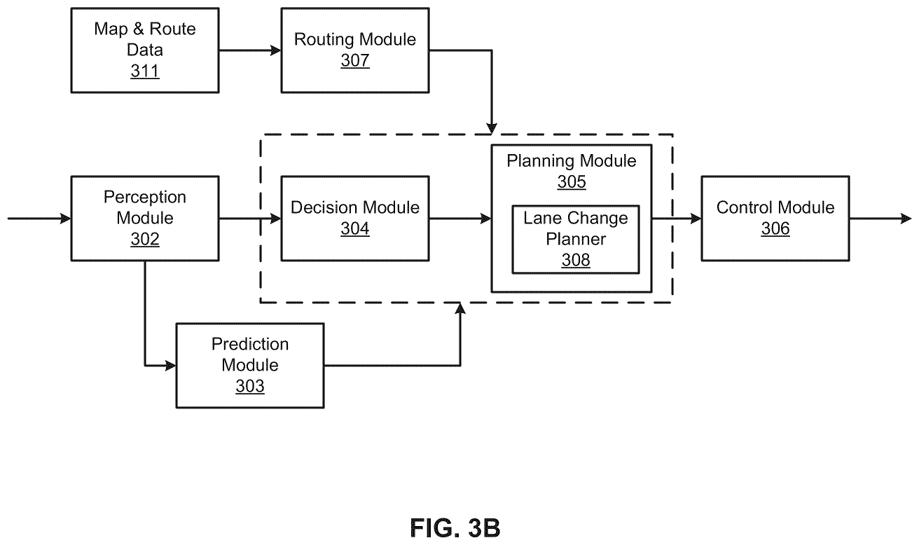

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305 (including lane change planner 308), control module 306, and routing module 307. The ADS 110 may further include a DP algorithms or models 314, which is used to determine a trajectory based on a plurality of cost function. In some embodiment, the lane change planner 308 plans for a long-distance lane change, which will be discussed in details below.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/rout information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 300 would move in a next moving cycle (e.g., next route/path segment). For example, the planning and control data may instruct vehicle 300 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

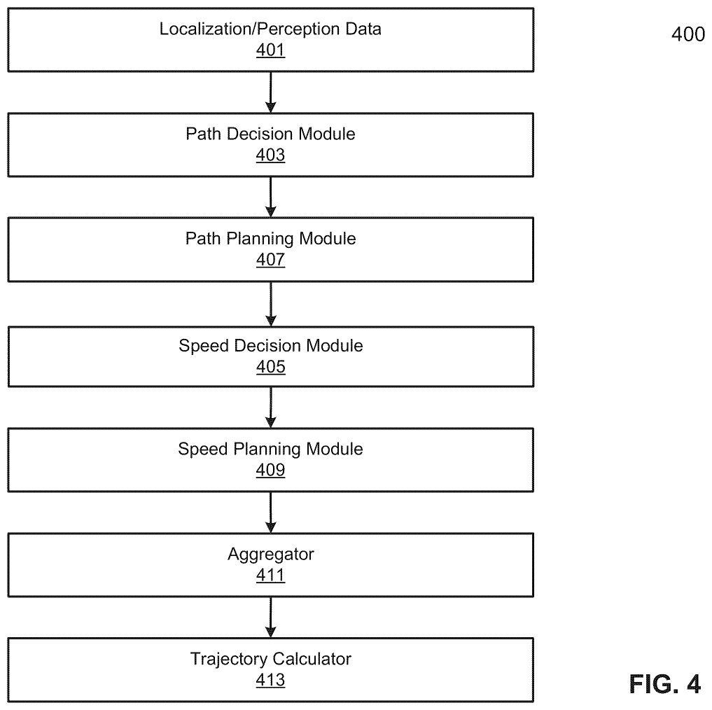

FIG. 4 is a block diagram illustrating an example of a decision and planning system according to one embodiment. System 400 may be implemented as part of autonomous driving system 300 of FIGS. 3A-3B to perform path planning and speed planning operations. Referring to FIG. 4, Decision and planning system 400 (also referred to as a planning and control or PnC system or module) includes, amongst others, routing module 307, localization/perception data 401, path decision module 403, speed decision module 405, path planning module 407, speed planning module 409, aggregator 411, and trajectory calculator 413.

Path decision module 403 and speed decision module 405 may be implemented as part of decision module 304. In one embodiment, path decision module 403 may include a path state machine, one or more path traffic rules, and a station-lateral maps generator. Path decision module 403 can generate a rough path profile as an initial constraint for the path/speed planning modules 407 and 409 using dynamic programming.

In one embodiment, the path state machine includes at least three states: a cruising state, a changing lane state, and/or an idle state. The path state machine provides previous planning results and important information such as whether the ADV is cruising or changing lanes. The path traffic rules, which may be part of driving/traffic rules 312 of FIG. 3A, include traffic rules that can affect the outcome of a path decisions module. For example, the path traffic rules can include traffic information such as construction traffic signs nearby the ADV can avoid lanes with such construction signs. From the states, traffic rules, reference line provided by routing module 307, and obstacles perceived by perception module 302 of the ADV, path decision module 403 can decide how the perceived obstacles are handled (i.e., ignore, overtake, yield, stop, pass), as part of a rough path profile.

For example, in one embedment, the rough path profile is generated by a cost function including costs based on: a curvature of path and a distance from the reference line and/or reference points to obstacles. Points on the reference line are selected and are moved to the left or right of the reference lines as candidate movements representing path candidates. Each of the candidate movements has an associated cost. The associated costs for candidate movements of one or more points on the reference line can be solved using dynamic programming for an optimal cost sequentially, one point at a time.

In one embodiment, a state-lateral (SL) maps generator (not shown) generates an SL map as part of the rough path profile. An SL map is a two-dimensional geometric map (similar to an x-y coordinate plane) that includes obstacles information perceived by the ADV. From the SL map, path decision module 403 can lay out an ADV path that follows the obstacle decisions. Dynamic programming (also referred to as a dynamic optimization) is a mathematical optimization method that breaks down a problem to be solved into a sequence of value functions, solving each of these value functions just once and storing their solutions. The next time the same value function occurs, the previous computed solution is simply looked up saving computation time instead of recomputing its solution.

Speed decision module 405 or the speed decision module includes a speed state machine, speed traffic rules, and a station-time graphs generator (not shown). Speed decision process 405 or the speed decision module can generate a rough speed profile as an initial constraint for the path/speed planning modules 407 and 409 using dynamic programming. In one embodiment, the speed state machine includes at least two states: a speed-up state and/or a slow-down state. The speed traffic rules, which may be part of driving/traffic rules 312 of FIG. 3A, include traffic rules that can affect the outcome of a speed decisions module. For example, the speed traffic rules can include traffic information such as red/green traffic lights, another vehicle in a crossing route, etc. From a state of the speed state machine, speed traffic rules, rough path profile/SL map generated by decision module 403, and perceived obstacles, speed decision module 405 can generate a rough speed profile to control when to speed up and/or slow down the ADV. The SL graphs generator can generate a station-time (ST) graph as part of the rough speed profile.

In one embodiment, path planning module 407 includes one or more SL maps, a geometry smoother, and a path costs module (not shown). The SL maps can include the station-lateral maps generated by the SL maps generator of path decision module 403. Path planning module 407 can use a rough path profile (e.g., a station-lateral map) as the initial constraint to recalculate an optimal reference line using quadratic programming. Quadratic programming (QP) involves minimizing or maximizing an objective function (e.g., a quadratic function with several variables) subject to bounds, linear equality, and inequality constraints.

One difference between dynamic programming and quadratic programming is that quadratic programming optimizes all candidate movements for all points on the reference line at once. The geometry smoother can apply a smoothing algorithm (such as B-spline or regression) to the output station-lateral map. The path costs module can recalculate a reference line with a path cost function, to optimize a total cost for candidate movements for reference points, for example, using QP optimization performed by a QP module (not shown). For example, in one embodiment, a total path cost function can be defined as follows:

path cost=Σₚₒᵢₙₜₛ(heading)²+Σₚₒᵢₙₜₛ(curvature)²+Σₚₒᵢₙₜₛ(distance)²,

where the path costs are summed over all points on the reference line, heading denotes a difference in radial angles (e.g., directions) between the point with respect to the reference line, curvature denotes a difference between curvature of a curve formed by these points with respect to the reference line for that point, and distance denotes a lateral (perpendicular to the direction of the reference line) distance from the point to the reference line. In some embodiments, distance represents the distance from the point to a destination location or an intermediate point of the reference line. In another embodiment, the curvature cost is a change between curvature values of the curve formed at adjacent points. Note the points on the reference line can be selected as points with equal distances from adjacent points. Based on the path cost, the path costs module can recalculate a reference line by minimizing the path cost using quadratic programming optimization, for example, by the QP module.

Speed planning module 409 includes station-time graphs, a sequence smoother, and a speed costs module. The station-time graphs can include a ST graph generated by the ST graphs generator of speed decision module 405. Speed planning module 409 can use a rough speed profile (e.g., a station-time graph) and results from path planning module 407 as initial constraints to calculate an optimal station-time curve. The sequence smoother can apply a smoothing algorithm (such as B-spline or regression) to the time sequence of points. The speed costs module can recalculate the ST graph with a speed cost function to optimize a total cost for movement candidates (e.g., speed up/slow down) at different points in time. For example, in one embodiment, a total speed cost function can be:

speed cost=Σₚₒᵢₙₜₛ(speed′)²+Σₚₒᵢₙₜₛ(speed″)²+(distance)²,

where the speed costs are summed over all time progression points, speed′ denotes an acceleration value or a cost to change speed between two adjacent points, speed″ denotes a jerk value, or a derivative of the acceleration value or a cost to change the acceleration between two adjacent points, and distance denotes a distance from the ST point to the destination location. Here, the speed costs module calculates a station-time graph by minimizing the speed cost using quadratic programming optimization, for example, by the QP module.

Aggregator 411 performs the function of aggregating the path and speed planning results. For example, in one embodiment, aggregator 411 can combine the two-dimensional ST graph and SL map into a three-dimensional SLT graph. In another embodiment, aggregator 411 can interpolate (or fill in additional points) based on two consecutive points on an SL reference line or ST curve. In another embodiment, aggregator 411 can translate reference points from (S, L) coordinates to (x, y) coordinates. Trajectory generator 413 can calculate the final trajectory to control ADV 510. For example, based on the SLT graph provided by aggregator 411, trajectory generator 413 calculates a list of (x, y, T) points indicating at what time should the ADC pass a particular (x, y) coordinate.

Thus, path decision module 403 and speed decision module 405 are configured to generate a rough path profile and a rough speed profile taking into consideration obstacles and/or traffic conditions. Given all the path and speed decisions regarding the obstacles, path planning module 407 and speed planning module 409 are to optimize the rough path profile and the rough speed profile in view of the obstacles using QP programming to generate an optimal trajectory with minimum path cost and/or speed cost.

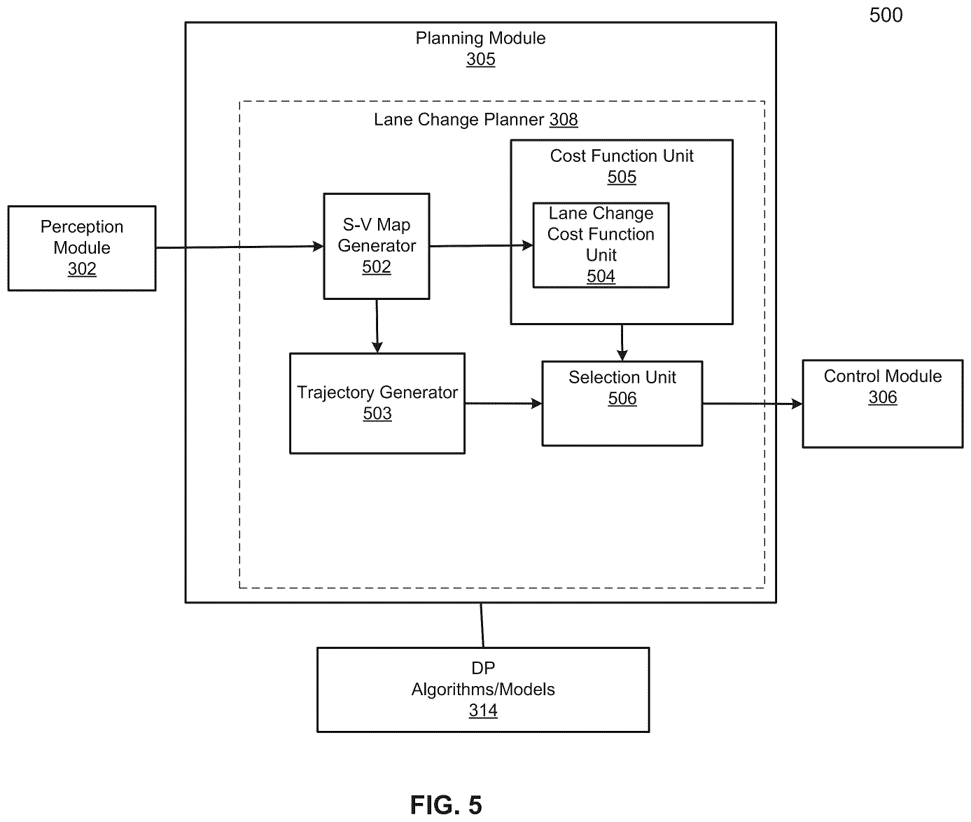

FIG. 5 is a block diagram 500 illustrating a lane change planner 308 used with an autonomous driving vehicle according to one embodiment. Referring to FIG. 5, the lane change planner 308 includes, but is not limited to, S-V map generator 502, trajectory generator 503, cost function unit 505 (including lane change cost function unit 504), and selection unit 506, which work together using DP algorithms or models 314 to perform a long-distance lane change of the ADV. Note that modules 502-506 may be integrated into fewer number of modules or a single module.

According to some embodiments, perception module 302 is configured to perceive a driving environment based on sensor data obtained from a plurality of sensors mounted on the ADV, including obtaining information of one or more obstacles on an adjacent lane. In response to a request to make a lane change from a current lane on which the ADV is driving to the adjacent lane, S-V map generator 502 is configured to generate an S-V map based on the information of the one or more obstacles. Each point on the S-V map represents a state of the ADV including a location and a speed of the ADV. Trajectory generator 503 is configured to generate a plurality of trajectories of the ADV using dynamic programming based on the S-V map. Lane change cost function unit 504 is configured to determine a lane change cost function based on the S-V map. Cost function unit 505 is configured to determine a plurality of cost functions involving multiple measurements including smoothness, safety, efficiency, traffic rules, and/or the lane change cost function. Selection module 606 is configured to select a trajectory from the plurality of trajectories based on the plurality of cost functions. Control module 306 is configured to control the ADV to drive autonomously according to the selected trajectory to make the lane change to the adjacent lane and avoid the one or more obstacles.

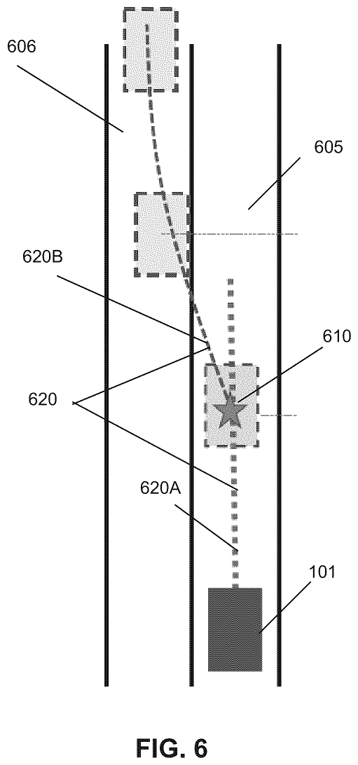

FIG. 6 illustrates an example of a long-distance lane change planning of an ADV 101 according to one embodiment. As illustrated in FIG. 6, the ADV 101 may be driving on a current lane 605. The ADV 101 may receive a request to make lane change to an adjacent lane 606. It is challenging to find a gap such that the ADV 101 can safely to make the lane change. For example, there may be one or more obstacles (not shown) on the adjacent lane. The ADV may collide into one of the obstacles. Conventional approaches may try to plan the lane change in every planning cycle in response to the request to change the lane. However, the conventional approaches have a low success rate and consume a lot computing resources.

In the long-distance lane change described herein, a lane change process may be decomposed into a preparation phase and a lane change phase. In the preparation phase, the ADV 101 may drive straight within the current lane 605 with varying speeds in a preparation operating mode. In the lane change phase, the ADV 101 may maneuver towards the adjacent lane 606, which may be a target lane, in a lane change operating mode. The trajectory 620 of the ADV includes a first port 620A in the preparation operating mode and a second portion 620B in the lane change operating mode. In the first portion 620A, the ADV101 may drive straight within the lane 605 while the speed of the ADV may change. In the second portion 620A, the ADV 101 may drive towards the target lane or adjacent lane 606 with controlled speed. In one embodiment, there is an adjusting phase after the lane change phase, in which the ADV 101 may adjust in the adjacent lane 606 in an adjusting operating mode.

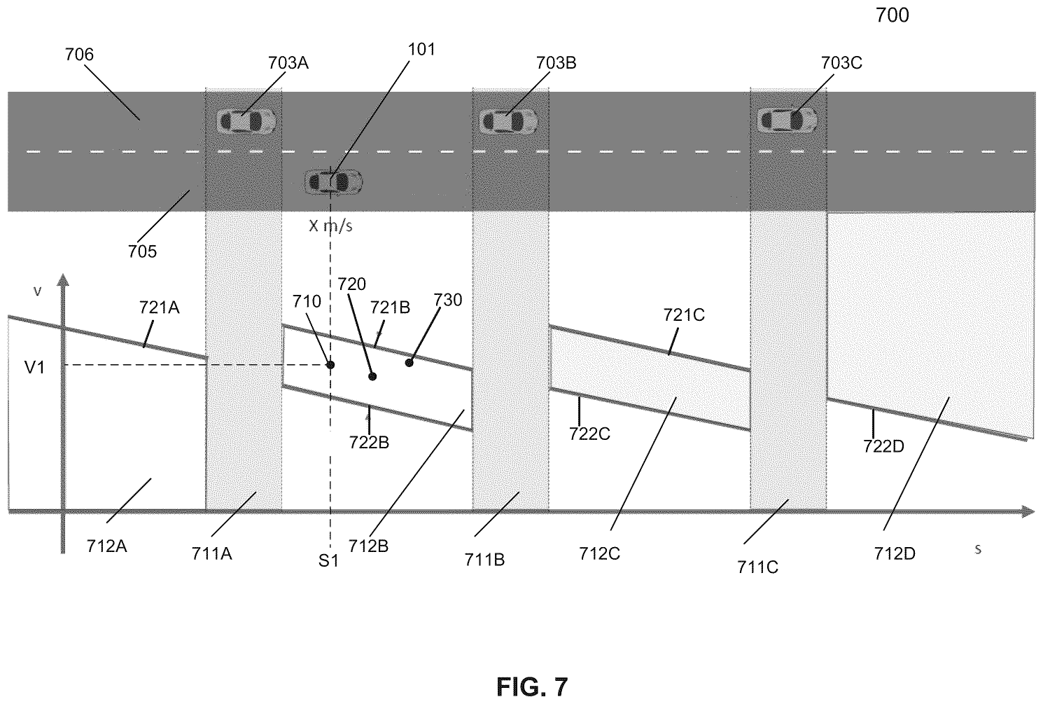

It is important to determine when and where is a transition spot 610, which is a goal, to switch the ADV 101 from the preparation mode to the lane change mode. The transition spot 610 (goal) to switch operating modes may be determined automatically using dynamic programming based on a S-V map, which will be discussed in detail below in FIG. 7. By dividing lane change process into the preparation phase and the lane change phase, the success rate of lane change is improved, thereby improving the computing efficiency.

FIG. 7 illustrates an example of generating an S-V map 700 according to one embodiment. S-V map 700 has an S location axis (e.g., horizontal axis), and a V axis. The S location axis represents a distance, e.g., a station distance, of the ADV, while the V axis represents a speed of the ADV. Each point on the S-V map representing a state of the ADV including a distance and a speed of the ADV. For example, S=2 may denote two meters ahead of a stationary reference point along a reference line. In one embodiment, the S location axis may be the horizontal axis or station axis in a station-lateral (SL) coordinates, which are a relative geometric coordinate system that references a particular stationary point on a reference line and follows the reference line. For example, a (S, L)=(2, 1) reference point can denote two meters ahead of the stationary reference point along the reference line and an one meter perpendicular lateral offset from the reference line, e.g., a left offset.

The S-V map 700 may be generated based on information of one or more obstacles 703A, 703B, 703C perceived by ADV 101. In one embodiment, the obstacles may also include moving vehicles, motorcycles, bicycles, pedestrians, animals, etc. The one or more obstacles may also include static obstacles, such as parked vehicles, motorcycles, bicycles, or structures. The information of obstacles 703A, 703B, 703C is projected into the S-V map 700. The S-V map 700 may be built based on the relative position of the obstacles 703A, 703B, 703C. The S-V map 700 may describe one or more feasible areas 712A, 712B, 712C, 712D for the ADV 101 to make the lane change. The feasible areas 712A-712D may be computed, e.g., based on the gaps between each two consecutive obstacles in the target lane 706.

As an example, referring to FIG. 7, the ADV 101 is driving on the current lane 705 while three obstacles 703A-703C are driving on the adjacent lane 706. The ADV 101 and each of the obstacles 703A-703C are driving with a same speed V1 of x m/s. The ADV 101 is driving straight on the current lane in the preparation operating mode. One or more feasible transition points (goals) may be determined based on the S-V map 700.

Each point in the blocks 711A-711C, along the side of one of the obstacles 703A-703C, represents a distance of the ADV 101 is the same as one of the obstacles 703A-703C. When the ADV 101 is within one of the blocks 711A-711C, the ADV 101 is driving side by side with one of the obstacles 703A-703C, thus the ADV 101 cannot make the lane change.

When the ADV 101 is driving in the gaps between each two consecutive obstacles, e.g., when the ADV is at the point 710 with the distance S1 and the speed V1, which is the same speed as the obstacles, it is safe for the ADV 101 to make the lane change. The point 710 is a feasible transition point for the ADV 101 to make the lane change. The point 710 represents a feasible state for the ADV to switch from the preparation operating mode to the lane change operating mode. Thus, the point 710 is one of the goals for the lane change. Similarly, points in the gaps between each two consecutive obstacles, having the same speed of the obstacles, are feasible transition points representing feasible states for the ADV to switch from the preparation operating mode to the lane change operating mode.

When the ADV 101 increases or decreases the speed from the same speed V1 of the obstacles exceeding certain limits, the ADV 101 may have a collision with the obstacle 703B or 703A when making the lane change. For example, when the ADV 101 at the distance S1 has a speed much faster than the obstacle 703B, the ADV 101 may have a collision with the obstacle 703B when making the lane change. The upper limit of the speed of ADV 101 at the distance S1 may be determined based on the speed of the obstacle 703B ahead of the ADV 101. The upper limit of the speed of ADV 101 at the distance S1 may be determined according to one or more predetermined objectives, including one or more obstacles on the target lane or adjacent lane, the speed of each of the one or more obstacles, buffer spaces between the ADV and each of the one or more obstacles. The upper limit of the speed of ADV 101 at the distance S1 may be computed according to physics laws, e.g., Newton laws.

Similarly, when the ADV 101 at the distance S1 has a speed much slower than the obstacle 703A, the ADV 101 may have a collision with the obstacle 70AB when making the lane change. The lower limit of the speed of ADV 101 at the distance S1 may be determined based on the speed of the obstacle 703A behind the ADV 101. The lower limit of the speed of ADV 101 at the distance S1 may be determined according to predetermined objectives including one or more obstacles on the target lane or adjacent lane, the speed of each of the one or more obstacles, buffer spaces between the ADV and each of the one or more obstacles. The lower limit of the speed of ADV 101 at the distance S1 may be computed according to physics laws, e.g., Newton laws.

In this way, for the points at each distance in the gaps between each two consecutive obstacles in the S-V map, the range of speeds, between the upper limit and the lower limit of the speed, feasible to make the lane change may be determined. Accordingly, the upper boundaries 721A-721C of the feasible areas 712A-712C may be determined based on the speed of the obstacle ahead of the ADV 101 and/or the one or more predetermined objectives. Similarly, the lower boundaries 722B-722D of the feasible areas 712B-712D may be determined based on the speed of the obstacle behind the ADV 101 and/or the one or more predetermined objectives. Therefore, the feasible areas 712A-712C, with the upper and lower boundaries, in the S-V map are determined. Each point in the feasible areas 712A-712C in the S-V map is a feasible transition point (e.g., a goal) for the ADV 101 to make the long-distance lane change. Each feasible transition point represents a feasible state for the ADV to switch from the preparation operating mode to the lane change operating mode.

As illustrated in FIG. 7, there are multiple feasible points (e.g., goals) representing multiple feasible states in the feasible areas 712A-712C in the S-V map. Dynamic programming may be used to select or choose one transition point from the multiple feasible transition points in the feasible areas 712A-712C in the S-V map. The transition point may be selected based on one or more factors including safety, comfort, efficiency, traffic rules, etc., which will be discussed below.

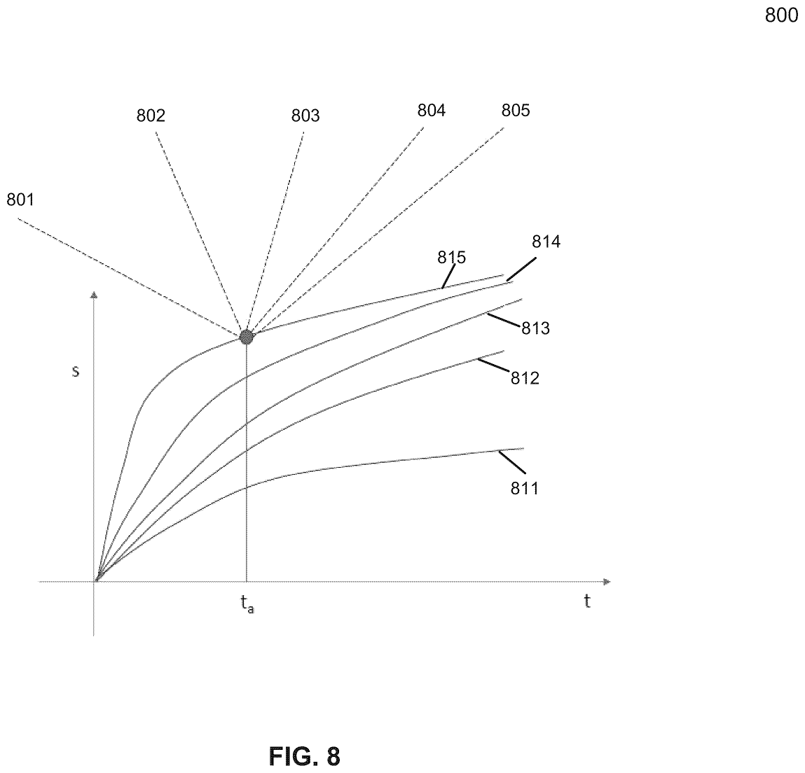

FIG. 8 is a diagram illustrating an example of planning a long-distance lane change using dynamic programming of an autonomous driving vehicle according to one embodiment. In FIG. 8, a station-time (ST) graph 800 illustrates a plurality of trajectories (811-815) of the ADV. Dynamic programming (also referred to as a dynamic optimization) is a mathematical optimization method that breaks down a problem to be solved into a sequence of value functions, solving each of these value functions just once and storing their solutions. The next time the same value function occurs, the previous computed solution is simply looked up saving computation time instead of recomputing its solution. Once the S-V map is built for the ADV, dynamic programming may be performed to search for the best trajectory that optimizes a metric from the plurality of trajectories (811-815). The metric involves multiple measurements including lane changing feasibility, smoothness, safety, efficiency and/or speed constraints. In some embodiments, the multiple measurements may be represented by cost functions, and the metric may be represented by a combination cost function.

In some examples, a lane change cost function may be determined based on the S-V map. A lane change cost, which is a value of the lane change cost function may be determined based on a position of a corresponding point in the S-V map. For example, referring back to FIG. 7, for a point outside the feasible areas 712A-712D, a value of the lane change cost function may be infinite. When the ADV having a state represented by the point outside the feasible areas 712A-712D, the value of the lane change cost function may be infinite. Thus, dynamic programming may guide the ADV to move into the feasible areas 712A-712D.

In one embodiment, each point within the feasible areas may have a same value of the lane change cost function. For example, referring back to FIG. 7, each point within the feasible areas 712A-712D has a same value of the lane change cost function, e.g., a low value.

In one embodiment, different points within the feasible areas may have different values of the lane change cost function. For example, referring back to FIG. 7, a center point 720 of the feasible area 712B may have a lower value of the lane change cost function than a point 730 near a boundary 721B of the feasible area. The points near the center point 720 may have a lower value of the lane change cost function than the points near the boundary 721B of the feasible area. The lane change cost of all the points within the feasible areas 712A-712D may be calculated. The feasible transition points with a lane change cost below a predetermined threshold may be determined.

Referring back to FIG. 8, the plurality of trajectories (811-815) may be generated by dynamic programming, as illustrated in the ST graph 800. Dynamic programming may be performed to search for the best trajectory based on a plurality of cost functions, or a combination of the plurality cost functions. The plurality of cost functions may include the lane change cost function 801, as discussed above. The plurality of cost functions may further include a safety cost function 802, a comfort cost function 803, an efficiency cost function 804 and/or a traffic law cost function 805. The safety cost function may be determined based a probability of collision. The comfort cost function may be determined based on a comfort level of passengers in view of acceleration, jerks, etc. The efficiency cost function may be determined based an efficiency of the ADV. The traffic law cost function may be determined based on traffic rules/laws, such as speed limit.

In one embodiment, a combination cost function based on a combination of the plurality of cost functions (801-805) may be generated. Dynamic programming may be performed to select a trajectory from the plurality of trajectories based on a lowest cost value of the combination cost function.

As an example, dynamic programming may be used to generate the plurality of trajectories 811-815 in the ST graph 800. Each trajectory of the plurality of trajectories 811-815 may have multiple points, e.g., 80 points. For each point, a cost value may be calculated as below:

Cost C=Cost 1+Cost 2+Cost 3+Cost 4+Cost 5.

In this example, Cost 2 may be associated with the safety cost function 802, Cost 3 may be associated with the comfort cost function 803, Cost 4 may be associated with the efficiency cost function 804, Cost 5 may be associated with the traffic law cost function 805, and Cost 1 may be associated with the lane change cost function 801 based on the S-V map (e.g., 700). As discussed above, referring back to FIG. 7, Cost 1, which is the value of the lane change cost function, may be infinite for a point outside the feasible areas 712A-712D. Cost 1 may have a low value for a point within the feasible areas 712A-712D.

Then, for each of the plurality of trajectories 811-815, the cost values of all the multiple points, e.g., 80 points, may be summed up to get a total cost value of the trajectory. Dynamic programming may be used to choose one trajectory of the plurality of trajectories with the lowest total cost value.

As another example, for each point, a score may be calculated as below:

Score S=Score 1+Score 2+Score 3+Score 4+Score 5.

In this example, Score 2 may be associated with the safety cost function 802, Score 3 may be associated with the comfort cost function 803, Score 4 may be associated with the efficiency cost function 804, Score 5 may be associated with the traffic law cost function 805, and Score 1 may be associated with the lane change cost function 801 based on the S-V map (e.g., 700). The higher the score, the lower the cost value. Thus, Score 1 may be zero or a low value for a point outside the feasible areas 712A-712D, and Score 1 may be high for a point within the feasible areas 712A-712D. Then, for each of the plurality of trajectories 811-815, the scores of all the multiple points, e.g., 80 points, may be summed up to get a total score of the trajectory. Dynamic programming may be used to choose one trajectory of the plurality of trajectories with the highest score.

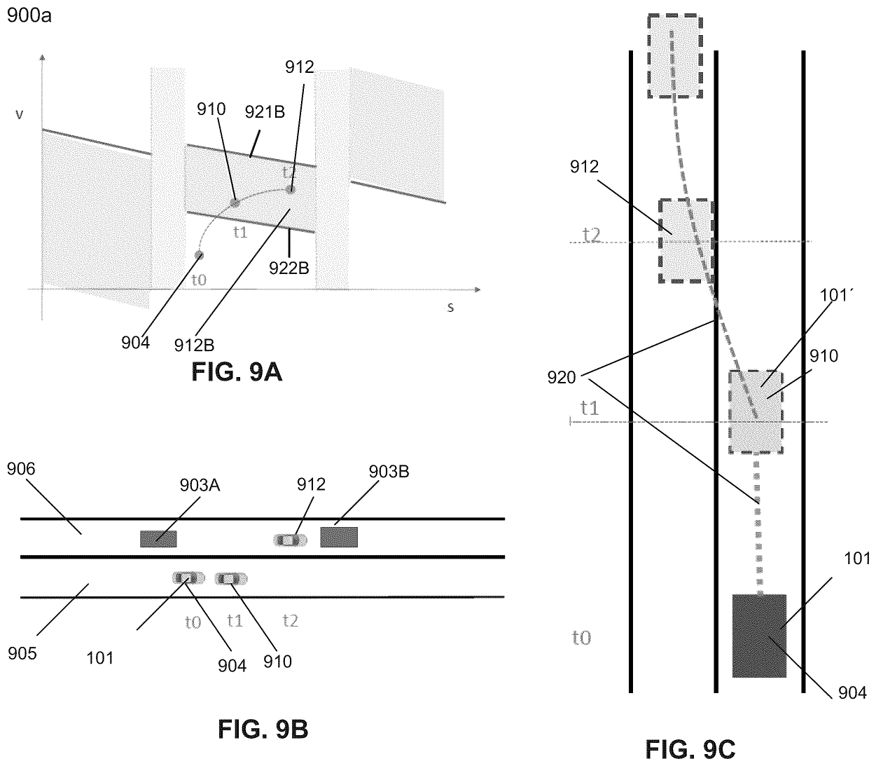

FIGS. 9A-9C illustrate an example of planning a long-distance lane change of an autonomous driving vehicle based on an S-V map according to one embodiment. FIG. 9A illustrates an S-V map 900a, e.g., generated based on obstacles 903A, 903B. The S-V map 900a may be similar to the S-V map 700 described in connection with FIG. 7. FIG. 9B illustrates an ADV 101 is driving on a current lane 905, while obstacles 903A, 903B are driving on an adjacent lane 906. FIG. 9C illustrates a selected trajectory 920 for the ADV 101 to make the lane change.

Referring to FIGS. 9A-9C, at time to, the ADV 101 is at the point 904 in the S-V map 900a, which is outside the feasible area 912B. The point 904 represents a state of the ADV 101 including a distance and a speed of the ADV 101 at the time t0. Each point within the feasible area 912B represents a feasible state for the AD 101 to make a long-distance lane change. Each point outside the feasible area 912B represents an infeasible state for the AD 101 to make a long-distance lane change. Thus, the lane change cost for the point 904 is infinite, and dynamic programming may guide the ADV 101 to increase the speed and move into the feasible area 912B in the S-V map.

At time t1, the ADV 101 is at a transition point 910 (goal) in the S-V map 900a, which is within the feasible area 912B. The point 910 represents a state of the ADV 101 including a distance and a speed of the ADV 101 at the time t1. Dynamic programming may select the transition point 910 based on the S-V map 900a for the ADV to make the lane change. Dynamic programming may select the trajectory 920 of the ADV 101 from a plurality of trajectories based on a plurality of cost functions including the lane change cost function. From time t0 to time t1, the ADV 101 may drive straight in the correct lane 905 in the preparation operating mode. Then, the ADV 101 may make the lane change and switch from the preparation operating mode to the lane change operating mode.

From time t1 to time t2, the ADV 101 may move from the transition point 910 to a point 912 in the adjacent lane 906 in the lane change operating mode. The point 912 represents a state of the ADV 101 including a distance and a speed of the ADV 101 at the time t2. During the lane change operating mode, a state of the ADV 101 is kept within the feasible area 912B. The points representing the states of the ADV 101, during the lane change operating mode, are between the upper boundary 921B and the lower boundary 922B within the feasible area 912B.

At time t2, the ADV 901 is at the point 912, where the ADV changes to the target lane, the adjacent lane 906. As illustrated in FIG. 9A, the point 912 is below the upper boundary 921B of the feasible area 912B. Thus, the ADV 101 is making the lane change safely to avoid the collision with the obstacle 903B in front of the ADV 101.

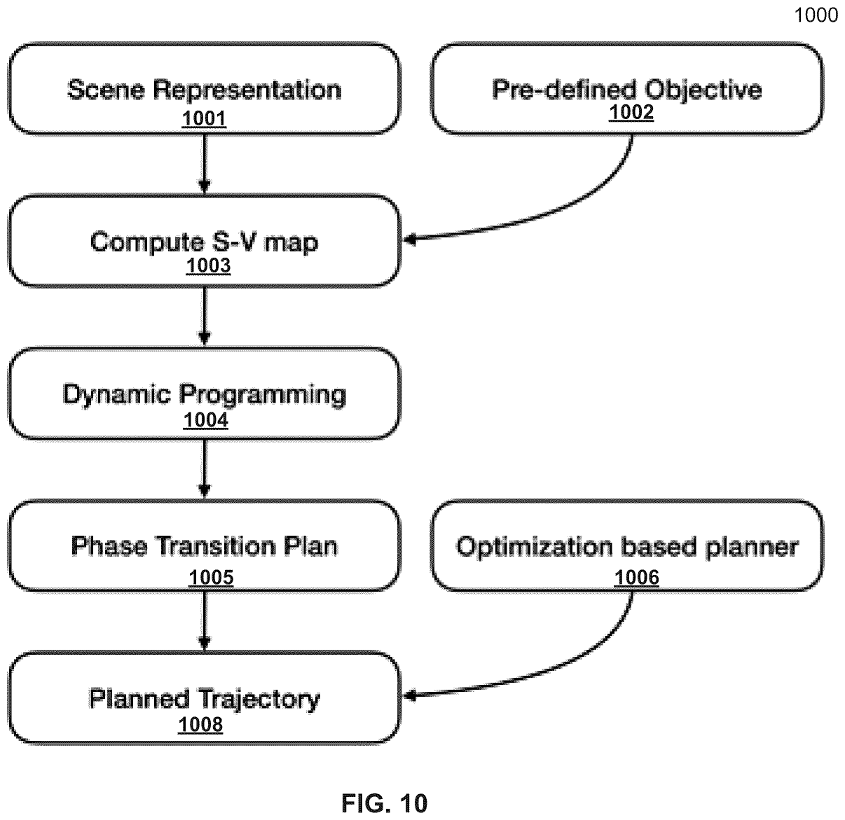

FIG. 10 is a flow diagram illustrating an example of a process 1000 of planning a long distance lane change of an autonomous driving vehicle according to one embodiment. Process 1000 may be performed by processing logic which may include software, hardware, or a combination thereof. For example, process 1000 may be performed by the planning module 305 including the lane change planner 308. Referring to FIG. 10, in operation 1001, processing logic perceives a driving scene based on sensor data obtained from a plurality of sensors mounted on the ADV, including obtaining information of one or more obstacles on an adjacent lane.

In operation 1002, one or more predefined objectives are determined. For example, the one or more predefined objectives may include one or more obstacles on the target lane or adjacent lane, the speed of each of the one or more obstacles, buffer spaces between the ADV and each of the one or more obstacles.

In operation 1003, an S-V map is generated based on the information of the one or more obstacles, each point on the S-V map representing a state of the ADV including a distance and a speed of the ADV. One or more areas in the S-V map which are feasible for the ADV to make the lane change may be determined based on the one or more predefined objectives. The information of obstacles may be projected into the S-V map. The S-V map 700 may be built based on the relative position of the obstacles. The upper and lower boundaries of the feasible areas may be determined based on the speed of the obstacle(s) and/or the one or more predetermined objectives.

In operation 1004, dynamic programming is used for optimization.

In operation 1005, a plurality of feasible transition points for the ADV to change from a preparation operating mode to a lane change operating mode may be determined using dynamic programming.

In operation 1006, an optimization based planner is used to select a trajectory from a plurality of trajectories, e.g., selecting a speed profile, based on a plurality of cost functions.

In operation 1008, the trajectory for the ADV to make the lane change is planned. By this process, the ADV may plan a long-distance lane change under all conditions. The trajectory is selected based on lane change feasibility, safety, comfort and efficiency. The success rate of making a lane change is improved. In addition, the computing efficiency is improved, and therefore, the computing resources is saved.

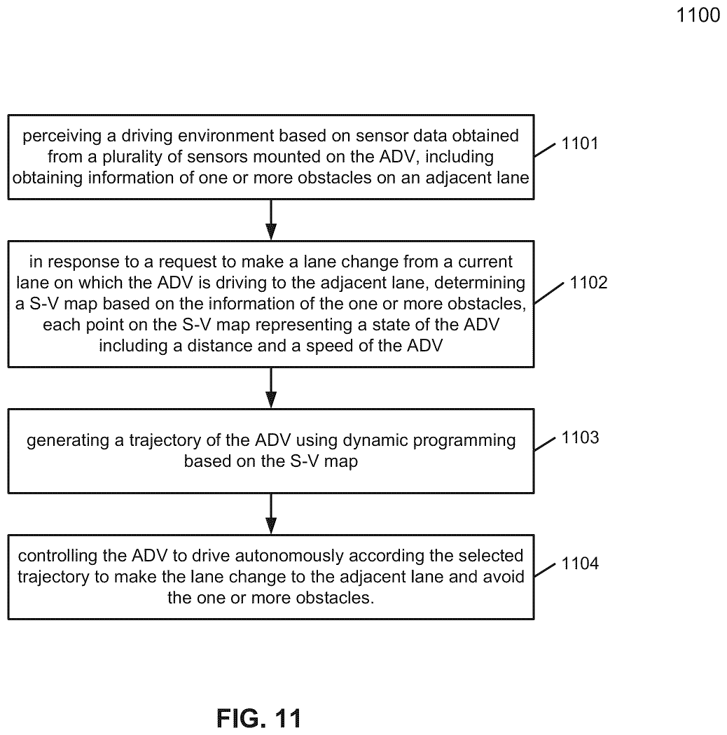

FIG. 11 is a flow diagram illustrating an example of a method 1100 of performing a long-distance lane change of an autonomous driving vehicle according to one embodiment. Method 1100 may be performed by processing logic which may include software, hardware, or a combination thereof. For example, method 1100 may be performed by the planning module 305 including the lane change planner 308. Referring to FIG. 11, in operation 1101, processing logic perceives a driving environment based on sensor data obtained from a plurality of sensors mounted on the ADV, including obtaining information of one or more obstacles on an adjacent lane.

In operation 1102, processing logic, in response to a request to make a lane change from a current lane on which the ADV is driving to the adjacent lane, generates an S-V map based on the information of the one or more obstacles, each point on the S-V map representing a state of the ADV including a distance and a speed of the ADV.

In operation 1103, processing logic generates a trajectory of the ADV using dynamic programming based on the S-V map.

In operation 1104, processing logic controls the ADV to drive autonomously according to the trajectory to make the lane change to the adjacent lane and avoid the one or more obstacles.

By this method, the ADV may plan a long-distance lane change under all conditions. The trajectory is selected based on lane change feasibility, safety, comfort and efficiency. The success rate of making a lane change is improved. In addition, the computing efficiency is improved, and therefore, the computing resources is saved.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method for operating an autonomous driving vehicle (ADV), the method comprising:
perceiving a driving environment based on sensor data obtained from a plurality of sensors mounted on the ADV, including obtaining information of one or more obstacles on an adjacent lane;
in response to a request to make a lane change from a current lane on which the ADV is driving to the adjacent lane, generating an S-V map based on the information of the one or more obstacles, each point on the S-V map representing a state of the ADV including a distance and a speed of the ADV;
generating a trajectory of the ADV using dynamic programming based on the S-V map; and
controlling the ADV to drive autonomously according to the trajectory to make the lane change to the adjacent lane and avoid the one or more obstacles.

2. The method of claim 1, further comprising:
determining one or more feasible areas in the S-V map, each point in the one or more areas representing a feasible state for the ADV to make the lane change.

3. The method of claim 2, wherein the lane change includes a preparation phase in which the ADV drives straight within the current lane in a preparation operating mode and a lane change phase in which the ADV maneuvers towards the adjacent lane in a lane change operating mode.

4. The method of claim 3, wherein the trajectory includes a first portion in which the ADV drives straight on the current lane in the preparation phase and a second portion in which the ADV makes a lane change towards the adjacent lane in the lane change phase.

5. The method of claim 3, further comprising:
determining a transition point in the one or more areas in the S-V map for the ADV to switch from the preparation operating mode to the lane change operating mode based on a plurality of cost functions.

6. The method of claim 3, further comprising:
keeping a state of the AVD within the one or more areas in the S-V map during the lane change phase.

7. The method of claim 1, further comprising
determining a lane change cost function based on the S-V map.

8. The method of claim 7, wherein the determining the lane change cost function based on the S-V map comprises
determining a value of the lane change cost function based on a position of a corresponding point in the S-V map.

9. The method of claim 7, wherein a value of the lane change cost function is infinite for a corresponding point outside the one or more areas in the S-V map.

10. The method of claim 7, wherein the generating the trajectory of the ADV using dynamic programming based on the S-V map comprises
generating a plurality of trajectories of the ADV; and
selecting a trajectory from the plurality of trajectories using dynamic programming based on a plurality of cost functions including the lane change cost function.

11. The method of claim 10, wherein the plurality of cost functions further includes at least one of a safety cost function, a comfort cost function, an efficiency cost function or a traffic law cost function.

12. The method of claim 10, wherein the selecting the trajectory from the plurality of trajectories based on the plurality of cost functions comprises:
determining a combination cost function based on a combination of the plurality of cost functions; and
selecting a trajectory from the plurality of trajectories based on a lowest cost value of the combination cost function.

13. A non-transitory machine-readable medium having instructions stored therein, which when executed by a processor, cause the processor to perform operations, the operations comprising:
perceiving a driving environment based on sensor data obtained from a plurality of sensors mounted on an autonomous driving vehicle (ADV), including obtaining information of one or more obstacles on an adjacent lane;
in response to a request to make a lane change from a current lane on which the ADV is driving to the adjacent lane, generating an S-V map based on the information of the one or more obstacles, each point on the S-V map representing a state of the ADV including a distance and a speed of the ADV;
generating a trajectory of the ADV using dynamic programming based on the S-V map; and
controlling the ADV to drive autonomously according to the trajectory to make the lane change to the adjacent lane and avoid the one or more obstacles.

14. The machine-readable medium of claim 13, wherein the operations further comprise:
determining one or more feasible areas in the S-V map, each point in the one or more areas representing a feasible state for the ADV to make the lane change.

15. The machine-readable medium of claim 14, wherein the lane change includes a preparation phase in which the ADV drives straight within the current lane in a preparation operating mode and a lane change phase in which the ADV maneuvers towards the adjacent lane in a lane change operating mode.

16. The machine-readable medium of claim 13, wherein the operations further comprise:
determining a lane change cost function based on the S-V map.

17. The machine-readable medium of claim 16, wherein the operations further comprise:
generating a plurality of trajectories of the ADV; and
selecting a trajectory from the plurality of trajectories using dynamic programming based on a plurality of cost functions including the lane change cost function.

18. A data processing system, comprising:
a processor; and
a memory coupled to the processor to store instructions, which when executed by the processor, cause the processor to perform operations, the operations including
perceiving a driving environment based on sensor data obtained from a plurality of sensors mounted on the ADV, including obtaining information of one or more obstacles on an adjacent lane;
in response to a request to make a lane change from a current lane on which the ADV is driving to the adjacent lane, generating an S-V map based on the information of the one or more obstacles, each point on the S-V map representing a state of the ADV including a distance and a speed of the ADV;
generating a trajectory of the ADV using dynamic programming based on the S-V map; and
controlling the ADV to drive autonomously according to the trajectory to make the lane change to the adjacent lane and avoid the one or more obstacles.

19. The system of claim 18, wherein the operations further comprise:
determining one or more feasible areas in the S-V map, each point in the one or more areas representing a feasible state for the ADV to make the lane change.

20. The system of claim 18, wherein the operations further comprise:
determining a lane change cost function based on the S-V map;
generating a plurality of trajectories of the ADV; and
selecting a trajectory from the plurality of trajectories using dynamic programming based on a plurality of cost functions including the lane change cost function.
